(19) United States
(12) Patent Application Publication
(10) Pub. No.: US 2014/0215378 A1
(43) Pub. Date: Jul. 31, 2014

(54) One-Line Login

(71) Applicant: COMVERSE, INC., Wakefield, MA (US)

(72) Inventors: Amit Braytenbaum, Lehavim (IL); Sarit Morezky, Tel Aviv (IL)

(73) Assignee: COMVERSE, INC., Wakefield, MA (US)

(21) Appl. No.: 13/755,574

(22) Filed: Jan. 31, 2013

(51) Int. Cl. G06F 3/048

(52) U.S. Cl. CPC G06F 3/048
USPC 715/780

(57) ABSTRACT

There is provided a method that includes (a) presenting, on a display of a user interface, a line for entry of data, (b) receiving, from the user interface, a first string of data, (c) presenting a representation of the first string of data, on the display, on the line, (d) receiving, from the user interface, data that represents a space, (e) presenting a representation of the space, on the display, on the line, (f) receiving, from the user interface, a second string of data, (g) presenting a representation of the second string of data, on the display, on the line, (h) accepting the first string of data as a first parameter, and (i) accepting the second string of data as a second parameter. There is also provided an apparatus that performs the method, and a storage device that contains instructions for controlling a processor to perform the method.

### BACKGROUND

1. Field of the Disclosure

The present disclosure relates generally to a technique for entry of data through a user interface, for example, entry of a username and a password for accessing a website on the Internet. The technique is particularly suitable for employment in a case of a user interface that does not have a “tab” key.

2. Background of the Disclosure

A user interacting with a computer is often required to enter information into a form that is presented to the user on a display. For example, for a user to access a website, the website often requires that the user enter a username and a password. Generally, the user is presented with a homepage for the website where the user must enter the username and the password. This procedure generally involves situating a cursor in a username field, entering the username in the username field, and then “tabbing”, i.e., depressing or selecting a tab function, to advance the cursor to a password field into which the user will then enter the password. This procedure can be tedious and time-consuming, and may also be more difficult when the user is entering information from a device that does not have a “tab” key. In this situation, the user must manually move the cursor.

The situation is more complex when a user needs to fill out a “form” of some nature, such as in the case of an employment or school application, or when the user is asked, for example, at a retail website, for shipping information and/or is entering credit card information to complete a purchase. In these situations, to execute the purchase, the user may be required to navigate between many fields of information, such as name, address, city, state, zip code, as well as telephone number, e-mail address and the like.

Therefore, a need exists to simplify the process of a user providing information, such as a username and a password, for an on-line form. Also, a need also exist to simplify login and “form”-filling for a user of a device, such as a “smart phone”, that does not have a “tab” key for providing movement between login information fields or between fields for filling out forms. In the case of “smart phones”, it is also helpful to accommodate those situations where the user may only have the ability or freedom to use one hand for the entry of such information.

These and other needs are met according to the present disclosure, as will be more fully described in the paragraphs that follow.

### SUMMARY

There is provided a method that includes (a) presenting, on a display of a user interface, a line for entry of data, (b) receiving, from the user interface, a first string of data, (c) presenting a representation of the first string of data, on the display, on the line, (d) receiving, from the user interface, data that represents a space, (e) presenting a representation of the space, on the display, on the line, (f) receiving, from the user interface, a second string of data, (g) presenting a representation of the second string of data, on the display, on the line, (h) accepting the first string of data as a first parameter, and (i) accepting the second string of data as a second parameter. There is also provided an apparatus that performs the method, and a storage device that contains instructions for controlling a processor to perform the method.

The technique described herein is applicable to any data entry operation and allows for combining any number of fields for which information is required. Thus, the technique is applicable to accessing a website that requires, for example, two items of information, e.g., a username and a password, or for combining as many fields as may be required by the website. These include credit card payment information, billing/shipping information, employment application information, and the like.

### BRIEF DESCRIPTION OF THE DRAWINGS

FIG. 1 is a block diagram of a system 100 that employs the techniques described herein.

FIG. 2 is an illustration of a login screen having separate fields for a user to enter a username and a password.

FIGS. 3-7 are illustrations of a login screen having a single field for a user to enter a username and a password, i.e., a one-line login.

FIGS. 8(a)-8(c) illustrate a progression of a one-line login field as it changes during a login operation.

FIG. 9 is flowchart of a method for facilitating a one-line login on a home page of a website.

### DETAILED DESCRIPTION OF THE PREFERRED EMBODIMENTS

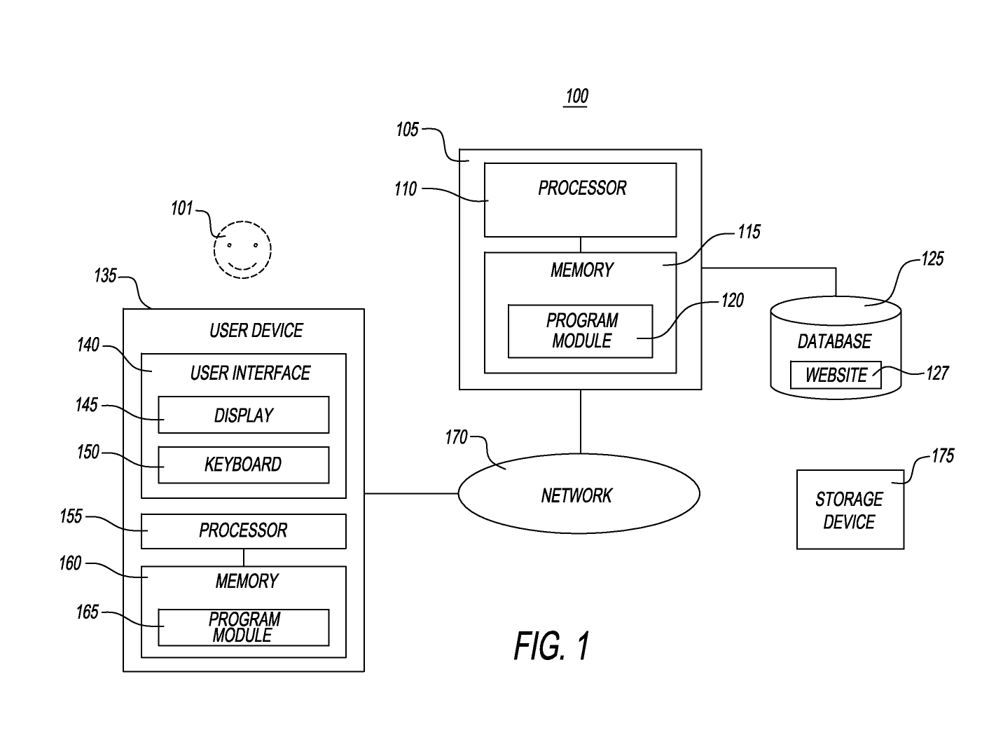

FIG. 1 is a block diagram of a system 100 that employs the techniques described herein. System 100 includes a computer 105 and a user device 135 that are communicatively coupled to one another via a network 170, e.g., the Internet.

Computer 105 includes a processor 110 and a memory 115. Although computer 105 is represented herein as a standalone device, it is not limited to such, but instead can be coupled to other devices (not shown) in a distributed processing system. Computer 105 hosts a website 127 on a database 125.

Processor 110 is an electronic device configured of logic circuitry that responds to and executes instructions.

Memory 115 is a tangible computer-readable storage device encoded with a computer program. In this regard, memory 115 stores data and instructions that are readable and executable by processor 110 for controlling the operation of processor 110. Memory 115 may be implemented in a random access memory (RAM), a hard drive, a read only memory (ROM), or a combination thereof. One of the components of memory 115 is a program module 120.

User device 135 includes a user interface 140, a processor 155 and a memory 160. User 101 utilizes user device 135 to access computer 105, and more specifically, website 127, via network 170. User device 135 may be implemented, for example, as a computer or a cell phone.

User interface 140 includes a display 145 and a keyboard 150. Display 135 is a device by which system 100 presents information in visual form to user 101. By way of keyboard 150, user 101 inputs information to user device 135 and computer 105. User interface 140 also includes a cursor control mechanism such as a mouse, track-ball, joy stick, or a touch-screen capability of display 145, that allows user 101 to manipulate a cursor on display 145 for communicating additional information and command selections to user device 135 and computer 105.

Processor 155 is an electronic device configured of logic circuitry that responds to and executes instructions.

Memory 160 is a tangible computer-readable storage device encoded with a computer program. In this regard, memory 160 stores data and instructions that are readable and executable by processor 155 for controlling the operation of processor 155. Memory 160 may be implemented in a RAM, a hard drive, a ROM, or a combination thereof. One of the components of memory 160 is a program module 165.

The term “module” is used herein to denote a functional operation that may be embodied either as a stand-alone component or as an integrated configuration of a plurality of subordinate components. Thus, each of program modules 120 and 165 may be implemented as a single module or as a plurality of modules that operate in cooperation with one another. Moreover, although program modules 120 and 165 are described herein as being installed in memory 115 and memory 160, respectively, and therefore being implemented in software, they could be implemented in any of hardware (e.g., electronic circuitry), firmware, software, or a combination thereof.

While program modules 120 and 165 are indicated as already being loaded into memories 115 and 160, respectively, they may be configured on a storage device 175 for subsequent loading into memories 115 and 160. Storage device 175 is a tangible computer-readable storage medium that stores program modules 120 and 165 thereon. Examples of storage device 175 include a compact disk, a magnetic tape, a read only memory, an optical storage media, a hard drive or a memory unit consisting of multiple parallel hard drives, and a universal serial bus (USB) flash drive. Alternatively, storage device 175 can be a random access memory, or other type of electronic storage device, located on a remote storage system (not shown) and coupled to computer 105 and user device 135 via network 170.

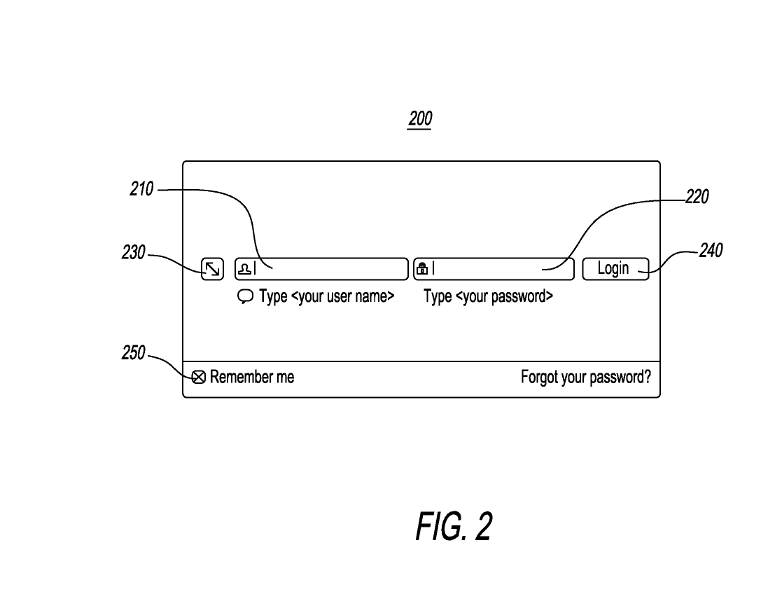

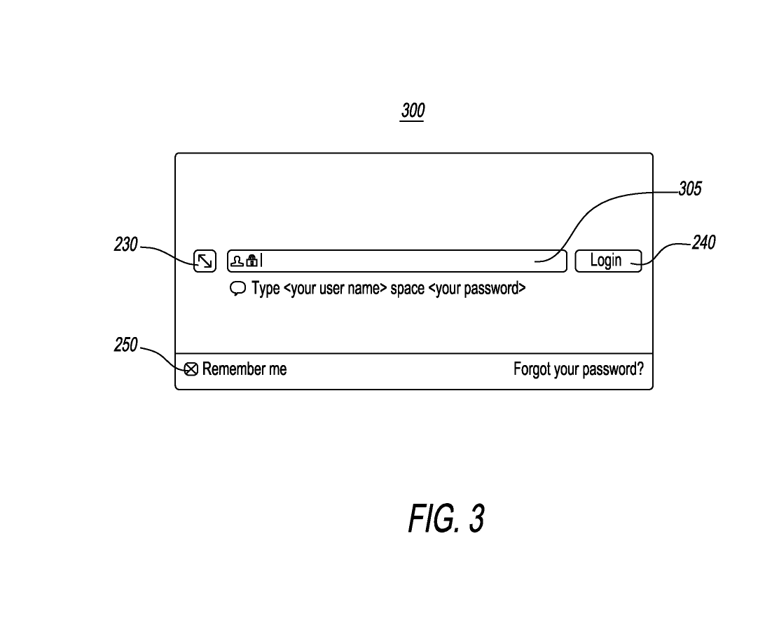

FIGS. 2 and 3 are illustrations of two login screens that are presented on display 145 for user 101 to log into website 127. FIG. 2 illustrates the first of the two login screens, designated as login screen 200, and FIG. 3 illustrates the second of the two login screens, designated as login screen 300. When user 101 wishes to log into website 127, user 101 will be required to enter a username and a password by way of keyboard 150. User 101 may employ either of login screen 200 or login screen 300 to enter the username and the password. Each of login screens 200 and 300 includes a toggle key 230. User 101 alternates between login screen 200 and login screen 300 by activating toggle key 230.

Referring to FIG. 2, login screen 200 includes, in addition to toggle key 230, a username field 210, a password field 220, a “Remember me” field 250, and a login key 240. To log into website 127 using login screen 200, user 101 enters the username in username field 210, and then either hits a “tab” key to advance a cursor to password field 220 or, alternatively, manually moves the cursor, using a mouse or some other means of cursor control, to password field 220, and enters the password. After the username has been inserted into username field 210 and password inserted into password field 220, user 101 activates login key 240, by either hitting “enter” on keyboard 150, or moving the cursor over login key 240 and activating login key 240 by clicking on an appropriate key of the mouse or other control device.

Referring to FIG. 3, login screen 300, similarly to login screen 200, includes toggle key 230, “Remember me” field 250, and login key 240. However, instead of username field 210 and password field 220, login screen 300 has a combined username/password field 305. Combined username/password field 305 is a line for entry of data. To log into website 127 using login screen 300, user 101 enters both of the username and the password into combined username/password field 305. More specifically, into combined username/password field 305, user 101 types the username followed by a space, and then types the password. Thereafter, user 101 activates login key 240.

For login screen 300, the “space” is used as a delimiter between the username and the password because the “space” key has an American Standard Code for Information Interchange (ASCII) value that is different from that of any other key, and conventional standards for usemame and password do not permit “spaces”.

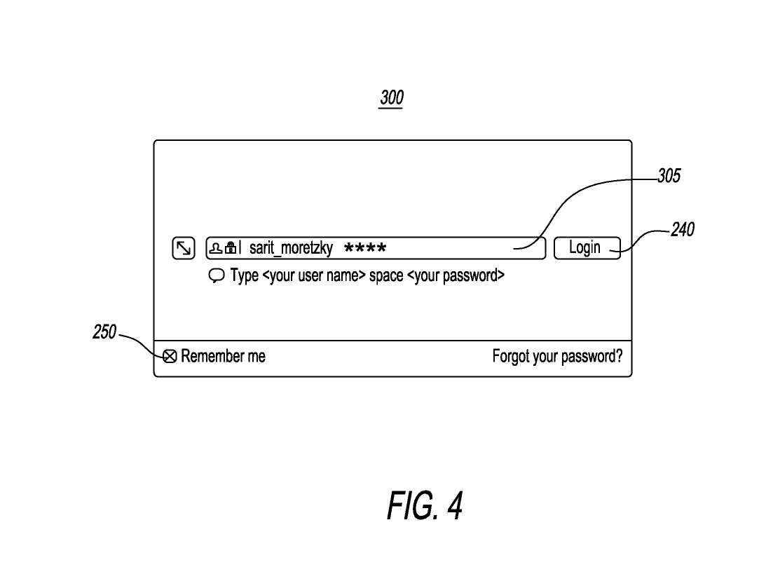

FIG. 4 is an illustration of login screen 300 for a case in which user 101 has logged in for the first time. User 101 has entered a username, i.e., “sarit_moretzky”, followed by a space and a password. The username is represented in combined username/password field 305 in the form of the characters that user 101 is typing, but password is represented in the form of asterisks so as to conceal it from a third party observer. “Remember me” field 230 is selected, as indicated by having an “x” therein, and as such, when user 101 activates login key 240, the state of “Remember me” field 230, and the username and the password, will be stored in either of memory 160 or memory 115, as explained further below.

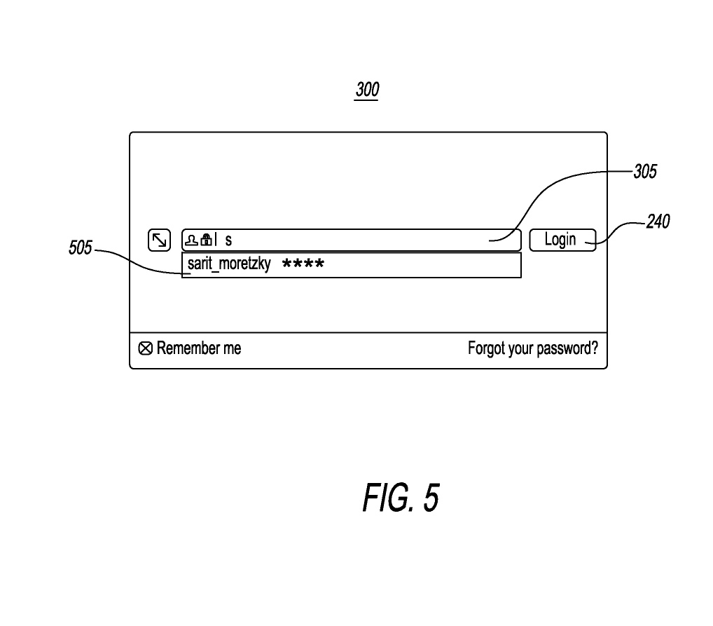

FIG. 5 is an illustration of login screen 300 for a case in which user 101 has previously logged in and selected “Remember me” field 250, as shown in FIG. 4. In FIG. 5, as user 101 begins to enter the usemame in combined username/password field 305 (illustrated in FIG. 5 by the “s” in combined username/password field 305), previously stored username(s) and password(s) is/are retrieved from the memory in which they were stored, i.e., memory 160 or memory 115, and a drop-down menu 505 is displayed, thus inviting user 101 to select a previously saved option therefrom. For example, in FIG. 5, user 101 begins by typing the letter “s”, and drop-down menu 505 presents a previously saved option of “sarit_moretzky****”.

In practice, login screen 300 may be utilized for accessing a plurality of different websites, and user 101 may have a different username and password for each of the websites. Thus, drop-down menu 505 may list more than one username and password.

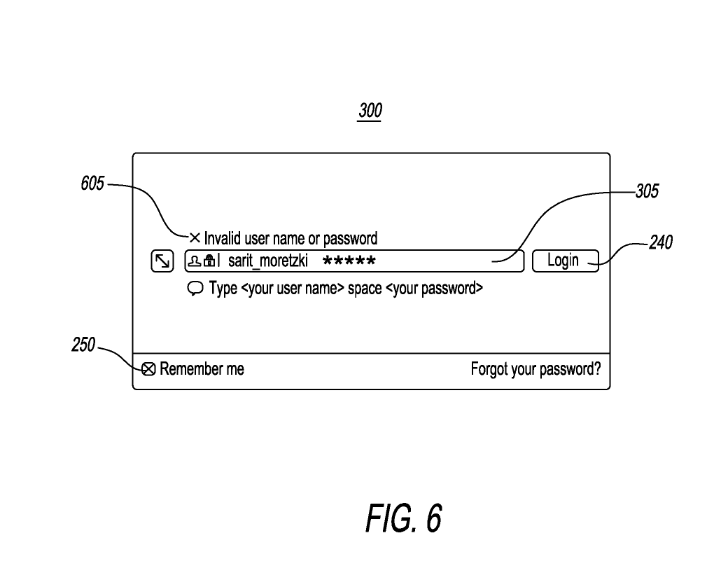

FIG. 6 is an illustration of an embodiment of login screen 300 that checks for errors in the usemame and password after user 101 activates login key 240. In this embodiment, user 101 has previously logged in and selected “Remember me” field 250, but for the present login has not selected a previously stored username and password, but instead, merely entered a username, a space and a password in combined usemame/password field 305, and selected login key 240. However, user 101 has entered one or both of an incorrect username or an incorrect password, and in the example shown in FIG. 6, entered both of an erroneous usemame, i.e., “sarit_moretzki” instead of “sarit_moretsky”, and an erroneous password, i.e., five characters instead of four characters. Accordingly, an error notice 605 is displayed stating “Invalid user name or password”.

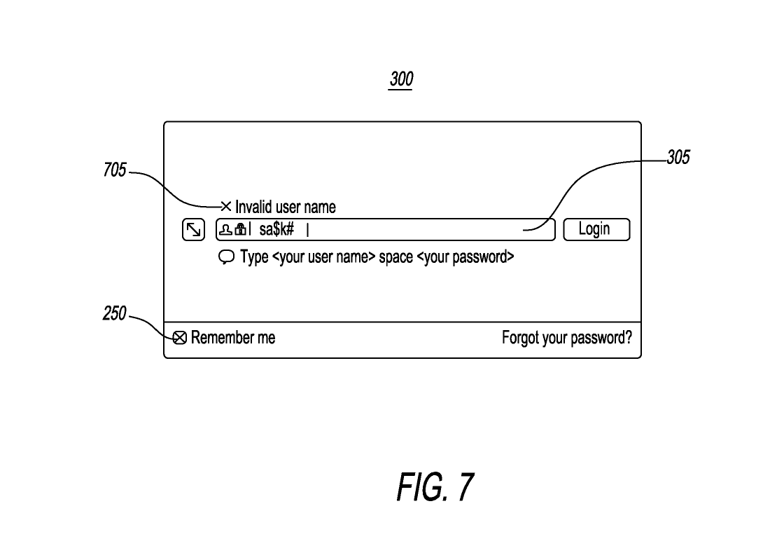

FIG. 7 is an illustration of an embodiment of login screen 300 that checks for errors in the usemame after user 101 enters a space. In this embodiment, user 101 has previously logged in and selected “Remember me” field 250. For the present login, user 101 has not selected a previously stored username and password but, instead, entered a username followed by a space in combined username/password field 305. However user 101 has entered an incorrect username, i.e., “sa$k#”. Accordingly, an error notice 705 is displayed stating “Invalid user name”.

Referring still to FIG. 7, but considering a slightly different operation, while user 101 is typing the username, error notice 705 could be generated as soon as user 101 types an invalid character, rather than after user 101 enters a space.

Offering the option of entering the usemame and password by way of combined usemame/password field 305 provides several advantages. First, on login screen 300, user 101 need not strike a “tab” key, nor manually move the cursor from username field 210 to password field 220, as on login screen 200, in order to enter complete login information. Instead, in combined usemame/password field 305, user 101 merely presses the “space” key to advance from one field to the next. Thus, when using login screen 300, there is less need for user interaction, and the entry of the username and password is less time consuming. Secondly, the use of the space key as a delimiter between the entry of the username and the entry of the password is useful in a case where a user interface does not include a tab key. Additionally, combined username/password field 305 can occupy less area than the discretely presented username field 210 and password field 220, and may therefore be regarded as being beneficial in a case of a small display or otherwise cluttered display.

A single field, or a single line for entry of data, similar to that of combined usemame/password field 305, is not limited to a case where the data represents parameters such as a username and a password, and is not limited to a case of two items of data. Instead, a single field or a single line for entry of data can also be used in situations where more than two data items need to be obtained from a user, where the data represents parameters other than a username and a password, and in situations other than accessing a website.

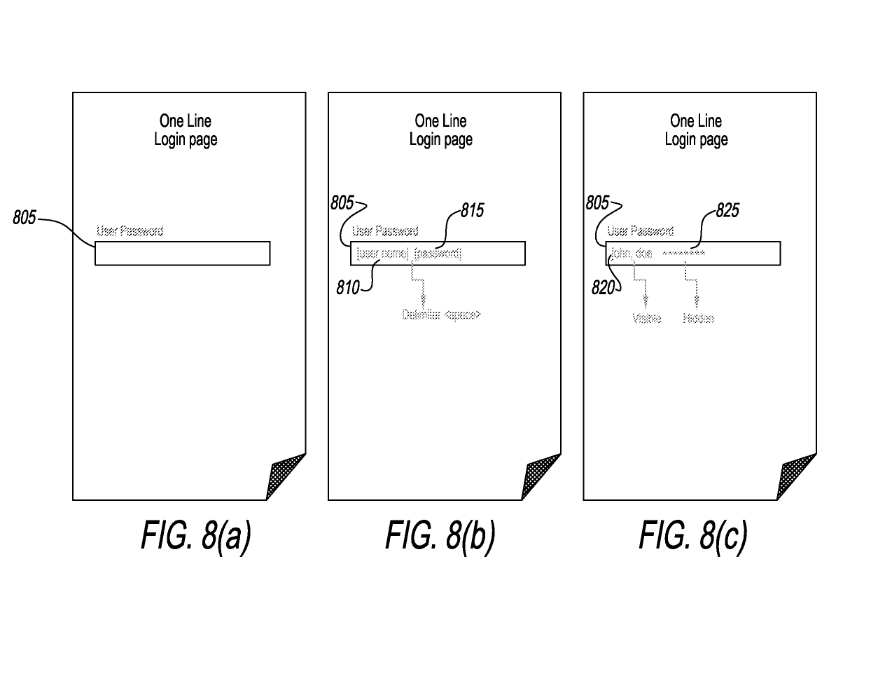

FIGS. 8(a)-8(c) illustrate a progression of a login field 805, i.e., a one-line login field, as it changes during a login operation. In FIG. 8(a), user 101 has not yet entered any data into login field 805, and so, login field 805 is empty. In FIG. 8(b), user 101 is prompted by “ghosted” wording 810 to enter a username, and after pressing the “space” key, user 101 is prompted by “ghosted” wording 815 to enter a password. In FIG. 8(c), after user 101 has entered the usemame and the password, the usemame is visible as indicated by username 820, while the password information is concealed and represented by asterisks 825.

Refer again to FIG. 2, and recall that login screen 200 is described above as advancing a cursor from usemame field 210 to password field 220 as a result of user 101 hitting a “tab” key. However, login screen 200 could be implemented to operate similarly to login screen 300, such that the advancement of the cursor from username field 210 to password field 220 results from user 101 hitting the “space” key.

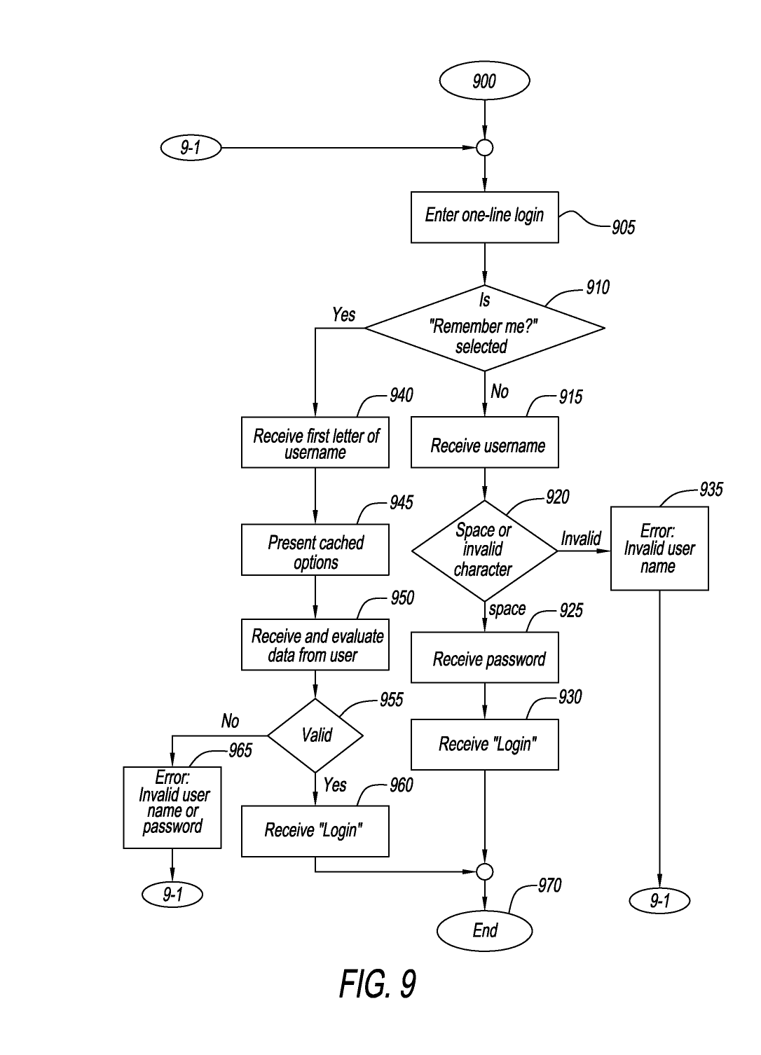

FIG. 9 is flowchart of a method 900 for facilitating a one-line login on a home page of website 127. Assume that user 101 is using user device 135. Method 900 commences with step 905.

In step 905, method 900 presents either of login screen 200 or login screen 300 on display 145, and user 101 activates toggle key 230, if necessary, so that method 900 presents login screen 300. From step 905, method 900 progresses to step 910.

In step 910, method 900 evaluates “Remember me” field 250. If “Remember me” field 250 is not selected, i.e., “Remember me” field 250 is clear, then method 900 progresses to step 915. If “Remember me” field 250 is selected, then method 900 progresses to step 940.

In step 915, method 900 prompts user 101 to enter a user name in combined username/password field 305. User 101 commences entry of the username in the form of a string of data by way of keyboard 150. Method 900 receives the string of data and presents, in combined usemame/password field 305, a representation of the string of data in the form of the characters that user 101 is entering. For example, if user 101 enters “sarit_moretzky”, method 900 displays “sarit_moretzky”. Upon completion of step 915, method 900 progresses to step 920.

In step 920, user 101 continues to enter the username, and method 900 continues to present a representation of the string in combined username/password field 305. Method 900 evaluates the string of data that it is being entered by user 101, until method 900 detects either of an invalid character, e.g., an impermissible character such as “#”, or a space. If method 900 detects a space, then method 900 advances to step 925. If method 900 detects an invalid character, then method 900 progresses to step 935.

In step 925, method 900 prompts user 101 to enter a password. User 101 enters the password in the form of a string of data by way of keyboard 150. Method receives the string of data and presents a representation of it in the form of asterisks for example, in combined username/password field 305. From step 925, method 900 progresses to step 930.

In step 930, user 101 selects login key 240. Method 900 recognizes the selection and progresses to step 970.

In step 935, which is being executed because in step 920, method 900 detected an invalid character, method 900 displays error notice 705, stating “Invalid user name”. Thereafter, method 900 loops back to step 905. In FIG. 9, the path from step 935 to step 905 is through a connecting bubble 9-1.

In step 940, which is being executed because “Remember me” field 250 is selected, method 900 prompts user 101 to enter a username in combined username/password field 305, and user 101 types the first letter of the username. The username is being entered in the form of a string of data. Method 900 receives the first letter of the usemame, i.e., method 900 receives the first character of the string of data, presents it in combined username/password field 305, and progresses to step 945.

In step 945, method 900 presents user 101 with a list of usemame/password pairs, i.e., cached options, by way of drop-down menu 505. From step 945, method 900 progresses to step 950.

In step 950, user 101 may either (a) select one of the username/password pairs from drop-down menu 505, or (b) enter the full username, followed by a space, followed by a password. Method 900 receives the usemame and the password, in the form of strings of data, presents a representation of them in combined username/password field 305, and evaluates the usemame and password. From step 950, method 900 progresses to step 955.

In step 955, method 900 considers the result of the evaluation that was performed in step 950. If user 101 selected a valid username/password from drop-down menu 505, or entered a correct username and a correct password, then method 900 advances to step 960. If user 101 either (a) selected an incorrect username/password from drop-down menu 505, e.g., user 101 selected a username/password for a different website, or (b) entered either of an incorrect usemame or an incorrect password, then method 900 progresses to step 965.

In step 960, user 101 selects login key 240. Method 900 recognizes the selection and progresses to step 970.

In step 965, which is being executed because user 101 has either (a) selected an incorrect username/password from drop-down menu 505, or (b) entered either of an incorrect username or an incorrect password, method 900 displays error notice 605, stating “Invalid user name or password”. From step 965, method 900 loops back to step 905. In FIG. 9, the path from step 965 to step 905 is through connecting bubble 9-1.

In step 970, method 900 accepts (a) as a username parameter, the string of data that user 101 entered for the username, and (b) as a password parameter, the string of data that user 101 entered for the password, and presents these parameters to website 127 to enable user 101 to access website 127. Method 900 then ends.

The techniques described herein are executed, at least in part, utilizing user interface 140. For example, login screen 300 would be presented on display 145, and user 101 would enter data by way of keyboard 150. Method 900 can be executed either (a) locally, on user device 135, by processor 155, or (b) remotely from user device 135, by processor 110 through its communication with user device 135. In this regard, method 900 can be performed by either of (a) processor 155, in accordance with instructions in program module 165, or (b) processor 110, in accordance with instructions in program module 120. When method 900 is performed by processor 155 in accordance with instructions in program module 165, program module 165 will utilize memory 160 for storage of the setting of “Remember me” field 250 and the contents of drop-down menu 505. When method 900 is performed by processor 110 in accordance with instructions in program module 120, program module 120 will utilize memory 115 for storage of the setting of “Remember me” field 250 and the contents of drop-down menu 505.

For example, assume that user device 135 is a phone with Internet connectivity, and that user 101 wishes to access website 127. Accordingly, program module 165 could be implemented as an “app” on user device 135. Processor 155, pursuant to instructions in program module 165:

(a) presents, on display 145, combined username/password field 305;

(b) receives, from user interface 140, and more specifically keyboard 150, a first string of data;

(c) presents a representation of the first string of data, on display 145, in combined username/password field 305;

(d) receives, from user interface 140, and more specifically keyboard 150, data that represents a space;

(e) presents a representation of the space, on display 145, in combined username/password field 305;

(f) receives, from user interface 140, and more specifically keyboard 150, a second string of data;

(g) presents a representation of the second string of data, on display 145, in combined username/password field 305;

(h) accepts the first string of data as a first parameter, e.g., a username; and

(i) accepts the second string of data as a second parameter, e.g., a password.

Additionally, the instructions in program module 165 can cause processor 155 to display toggle key 230 on display 145, and in response to receiving data that indicates a selection of toggle key 230, toggle between a display of login screen 200 and login screen 300.

In the alternative, processor 110 can perform the above-noted operations, pursuant to instructions in program module 120, through communication with user device 135 via network 160.

The terms “comprises” or “comprising” are to be interpreted as specifying the presence of the stated features, integers, steps or components, but not precluding the presence of one or more other features, integers, steps or components or groups thereof.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
presenting, on a display of a user interface, a line for entry of data;
receiving, from said user interface, a first string of data;
presenting a representation of said first string of data, on said display, on said line;
receiving, from said user interface, data that represents a space;
presenting a representation of said space, on said display, on said line;
receiving, from said user interface, a second string of data;
presenting a representation of said second string of data, on said display, on said line;
accepting said first string of data as a first parameter; and
accepting said second string of data as a second parameter.

2. The method of claim 2, further comprising, prior to said presenting said line:
presenting a toggle key on said display;
presenting, on said display, a first field for entry of said first string of data, and a second field, separate from said first field, for entry of said second string of data;
receiving, from said user interface, data that indicates a selection of said toggle key; and
toggling, on said display, between presenting (a) said line, and (b) said first field and said second field.

3. The method of claim 2, wherein said first parameter is a username, and said second parameter is a password.

4. An apparatus comprising:
a processor; and
a memory that contains instructions that are readable by said processor and cause said processor to:
present, on a display of a user interface, a line for entry of data;
receive, from said user interface, a first string of data;
present a representation of said first string of data, on said display, on said line;
receive, from said user interface, data that represents a space;
present a representation of said space, on said display, on said line;
receive, from said user interface, a second string of data;
present a representation of said second string of data, on said display, on said line;
accept said first string of data as a first parameter; and
accept said second string of data as a second parameter.

5. The apparatus of claim 5, wherein said instructions, prior to causing said processor to present said line, cause said processor to:
present a toggle key on said display;
present, on said display, a first field for entry of said first string of data, and a second field, separate from said first field, for entry of said second string of data;
receive data that indicates a selection of said toggle key; and
toggle, on said display, between presenting (a) said line, and (b) said first field and said second field.

6. The apparatus of claim 5, wherein said first parameter is a username, and said second parameter is a password.

7. A storage device comprising instructions that are readable by a processor and cause said processor to:
present, on a display of a user interface, a line for entry of data;
receive, from said user interface, a first string of data;
present a representation of said first string of data, on said display, on said line;
receive, from said user interface, data that represents a space;
present a representation of said space, on said display, on said line;
receive, from said user interface, a second string of data;
present a representation of said second string of data, on said display, on said line;
accept said first string of data as a first parameter; and
accept said second string of data as a second parameter.

8. The storage device of claim 8, wherein said instructions, prior to causing said processor to present said line, cause said processor to:
present a toggle key on said display;
present, on said display, a first field for entry of said first string of data, and a second field, separate from said first field, for entry of said second string of data;
receive data that indicates a selection of said toggle key; and
toggle, on said display, between presenting (a) said line, and (b) said first field and said second field.

9. The storage device of claim 8, wherein said first parameter is a username, and said second parameter is a password.
